(19) United States
(12) Patent Application Publication
(10) Pub. No.: US 2015/0115016 A1
(43) Pub. Date: Apr. 30, 2015

(54) BALL MOUNT MODULE

(71) Applicant: SAMSUNG ELECTRO-MECHANICS CO., LTD., Gyeonggi-Do (KR)

(72) Inventors: Sun Moon KIM, Deajeon-si (KR); Jung Hoon KIM, Seoul (KR)

(73) Assignee: SAMSUNG ELECTRO-MECHANICS CO., LTD., Gyeonggi-Do (KR)

(21) Appl. No.: 14/220,328

(22) Filed: Mar. 20, 2014

(30) Foreign Application Priority Data
Oct. 29, 2013 (KR) 10-2013-0129143

(51) Int. Cl. B23K 3/06

(52) U.S. Cl. CPC B23K 3/0623
USPC 228/41

(57) ABSTRACT

Embodiments of the invention provide a ball mount module for sucking and sticking balls positioned in a ball supply bath, transferring the balls, and mounting the balls on a ball pad of a substrate. The ball mount module includes a sucking head, a sucking base coupled to the sucking head and having irregular air channels, and a sucking and sticking panel including bail sucking and sticking holes formed therein so as to be in communication with the irregular air channels of the sucking base and coupled to the sucking head. The sucking base is made of ceramic.

### CROSS REFERENCE TO RELATED APPLICATION:

This application claims the benefit of and priority under 35 U.S.C. §119 to Korean Patent Application No. KR 10-2013-0129143, entitled, “Bail Mount Module,” filed on Oct. 29, 2013, which is hereby incorporated by reference in its entirety into this application.

### BACKGROUND

1. Field of the Invention

The present invention relates to a ball mount module, and more particularly, to a ball mount module for sucking and sticking balls positioned in a hall supply bath, transferring the balls, and mounting the balls on a ball pad of a substrate.

2. Description of the Related Art

Generally, in order to arrange unit cells designed in a process of manufacturing chips of a semiconductor device and connect the unit cells to each other, a process of selectively implanting impurities into a predetermined portion of a semiconductor substrate, a process of stacking insulating layers and conductive layers, a pattern mask process, and the like, are sequentially performed, such that integrated circuits are formed on the respective chips. The integrated circuit chips formed as described above are packaged by an assembling process.

A ball grid array (BGA) package among semiconductor packaging technologies is one of surface mounting type packages in which spherical solders are arranged in a line in an array form on a rear surface of a substrate in a semiconductor mounting technology instead of leads.

A process of packaging a BGA is generally configured to include a wafer mounting process, a die attaching process, a wire bonding process, a molding process, a marking process, a solder ball mounting process, a cleaning process, and a singulating process.

Among them, in the solder ball mounting process, a ball mount module positioned in a ball supply bath sucks and sticks balls and continuously mounts the balls on a ball pad of the substrate while repeatedly moving between the substrate and the ball supply bath.

However, in a ball mount module according to the related art, for example, in Korean Patent Laid-Open Publication No. 2003-0001031, a phenomenon that balls are fitted into an outer wall of a sucking and sticking channel occurs at the time of sucking and sticking the balls, such that the balls do not appropriately drop at the time of being mounted.

In order to prevent this problem, an opening part has been recently machined in the sucking and sticking channel so as to have a step or an increased diameter. However, since a. diameter of the sucking and sticking channel is very small, machinability is significantly deteriorated.

### SUMMARY

Accordingly, embodiments of the invention provide a ball mount module capable of being replaced and used depending on sizes of balls by including a sucking and sticking panel detachably disposed at a front end portion of a sucking base made of a porous ceramic material and sucking and sticking the balls.

Other embodiments of the invention provide a ball mount module capable of preventing sucked and stuck balls from being fitted by forming ball sucking and sticking holes so as to have an inner diameter larger at a lower portion thereof than at an upper portion thereof.

In accordance with an exemplary embodiment of the invention, there is provided a ball mount module including a sucking head, a sucking base coupled to the sucking head and having irregular air channels, and a sucking and sticking panel including ball sucking and sticking holes formed therein so as to be in communication with the irregular air channels of the sucking base and coupled to the sucking head. In accordance with at least one embodiment, the sucking base is made of ceramic.

In accordance with an embodiment of the invention, the sucking head is coupled to the sucking base while enclosing an upper surface and both side surfaces of the sucking base, and the sucking and sticking panel are detachably coupled to the sucking base.

In accordance with an embodiment of the invention, the sucking and sticking panel are coupled to the sucking base by bolts.

In accordance with an embodiment of the invention, the bail sucking and sticking hole are formed with an inner diameter that becomes larger from a portion thereof closely adhered to the sucking base toward the outside, and the sucking. and sticking panel include a plurality of ball sucking and sticking holes formed therein at predetermined intervals.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is an exploded perspective view showing a bail mount module, in accordance with an embodiment of the invention.

FIG. 2 is a cross-sectional view of the ball mount module, in accordance with an embodiment of the invention.

FIG. 3 is a view showing the state in which balls are sucked and stuck into the ball mount module, in accordance with an embodiment of the invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout. Prime notation, if used, indicates similar elements in alternative embodiments.

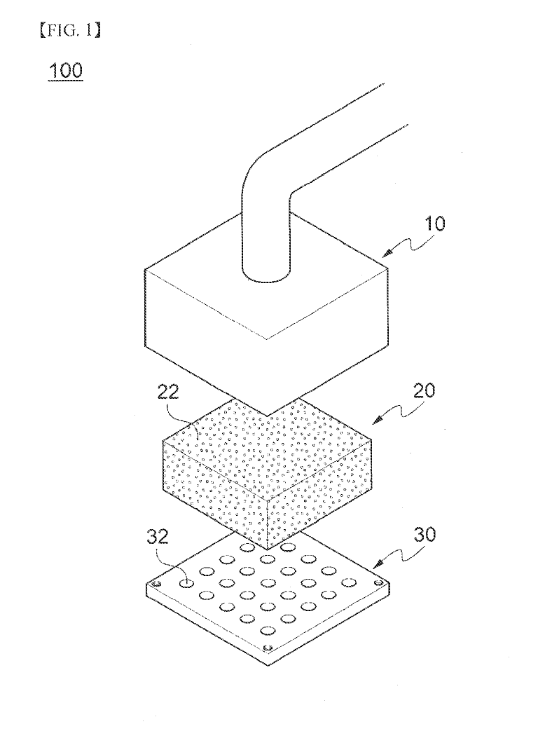

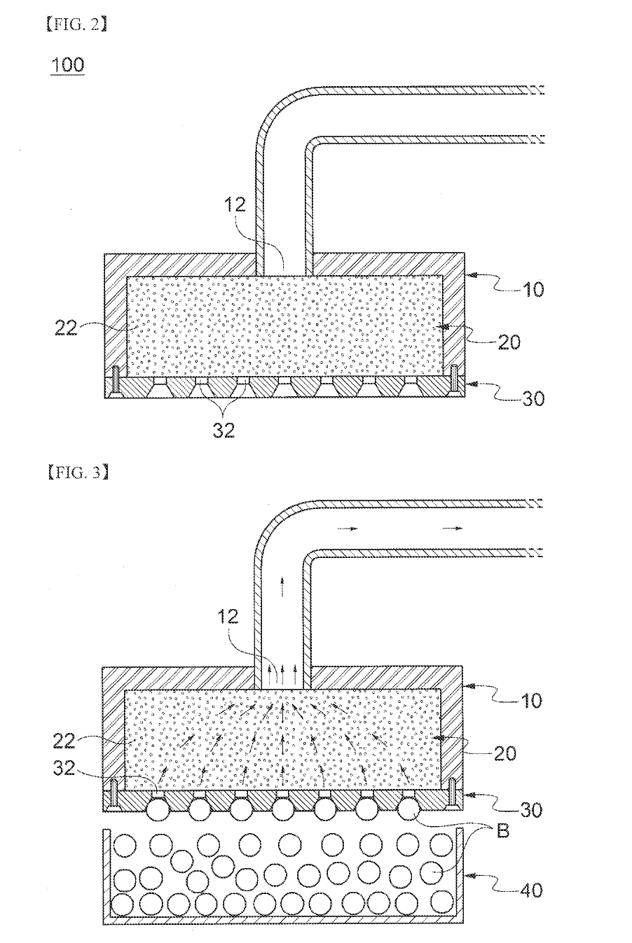

FIG. 1 is an exploded perspective view showing a ball mount module, in accordance with an embodiment of the invention; FIG. 2 is a cross-sectional view of the ball mount module, in accordance with an embodiment of the invention; and FIG FIG. 3 is a view showing the state in which balls are sucked and stuck into the ball mount module, in accordance with an embodiment of the invention.

As shown in FIGS. 1 to 3, the ball mount module 100 according to an embodiment of the present invention is configured to include a sucking head 10 sucking air, a sucking base 20 coupled to the sucking head 10, and a sucking and sticking panel 30 closely adhered to the sucking base 20 and coupled to the sucking head 10.

In accordance with at least one embodiment of the invention, the sucking, head 10 is manufactured by injecting a metal or a synthetic resin and has a hole 12 formed at a central portion thereof so that air may move, wherein the hole 12 has a predetermined size. In addition, although not shown, the hole 12 of the sucking head is connected to an air sucking pump, such that external air moves to the air sucking pump through the hole 12 by an operation of the air sucking pump.

In accordance with at least one embodiment of the invention, the sucking head 10 includes an accommodating space formed therein and has the sucking base 20 coupled thereto in order to close the accommodating space.

In accordance with at least one embodiment of the invention, the sucking base 20 includes a plurality of irregular air channels 22 formed therein. That is, the sucking base 20 includes the plurality of air channels 22 formed in an irregular form, similar to a ceramic in which a plurality of hole are formed, such that when suction of the air starts by the sucking head 10, the suction of the air is performed on all surfaces of the sucking base 20.

Because the sucking base 20 is in the state in which it is inserted into the accommodating space of the sucking head 10, the air is sucked only through a surface of the sucking base 20 exposed to the outside, that is, a lower surface of the sucking base 20.

In accordance with at least one embodiment of the invention, the sucking and sticking panel 30 formed in a metal mask form is coupled to the sucking head 10 to be closely adhered to the lower surface of the sucking base 20. The sucking and sticking panel 30 includes a plurality of ball sucking and sticking holes 32 formed therein so as to be in communication with the irregular air channels of the sucking base 20.

In accordance with at least one embodiment of the invention, the sucking and sticking panel 30 is coupled to the sucking head 10 by bolts. Therefore, the sucking and sticking panel 30 is not limited to being coupled to the sucking head 10 by the bolts, but may also be detachably coupled to the sucking head 10 in any structure.

In accordance with at least one embodiment of the invention, the bail sucking and sticking holes 32 are formed in the sucking and sticking panel 30 at predetermined intervals and suck balls B collected in a ball supply bath 40. The bail sucking and sticking hole 32 are formed to have an inner diameter that becomes larger from a portion thereof closely adhered to the sucking base 20 toward the outside.

In accordance with at least one embodiment of the invention, the sucking and sticking hole 32 is configured so as to have a diameter wider at a lower end portion thereof than at an upper end portion thereof in order to easily suck the ball B having a diameter corresponding to a fine pitch, for example, a diameter less than 0.4 min.

In accordance with at least one embodiment of the invention, the height of the ball sucking and sticking bole 32 is in the range in which it does not exceed a radius of the ball B.

The reason is that large frictional force may be generated due to an increase in a contact area between the ball sucking and sticking hole 32 and the ball B by suction force of the air sucked by the air sucking pump in the case in which the height of the ball sucking and sticking hole 32 exceeds the radius of the ball B. The frictional force generated as described above allows the ball B not to easily drop from the ball sucking and sticking hole 32 even after suction of the air is stopped by the air sucking pump.

Therefore, in accordance with at least one embodiment of the invention, it is preferable that the height of the ball sucking and sticking hole 32 does not exceed the radius of the ball B, so that the contact area between the ball B and the ball sucking and sticking hole 32 is minimized.

Hereinafter, an operation of the ball mount module according to the exemplary embodiment of the present invention will be described.

In order for the ball mount module 100 to suck a plurality of balls B collected in the ball supply bath 40 and then mount the plurality of balls B on a ball pad (not shown) of a substrate, a position controlling apparatus (not shown) is operated to position the ball mount module 100 over the ball supply bath 40.

In accordance with at least one embodiment of the invention, when the ball mount module 100 moves up to upper portions of the ball B collected in the ball supply bath 40, the air sucking pump (not shown) is operated to allow the air to be sucked through the sucking head 10.

When the suction of the air starts as described above, external air is introduced into the sucking base 20 through the ball sucking and sticking holes 32 of the sucking and sticking panel and moves to the air sucking pump through the air channels 22 of the sucking base.

When the external air starts to be sucked as described above, the balls B collected in the ball supply bath 40 are sucked and stuck while blocking the ball sucking and sticking holes 32, respectively.

When all of the ball sucking and sticking holes 32 are blocked by the balls B. the position controlling apparatus is operated to move the ball mount module 100 to a place at which the ball pad of the substrate is positioned and then perform ball mounting.

Further, in the case in which a size of balls mounted in another process after the ball mounting is continuously performed is different from that of the balls used in the above-mentioned process, after the sucking and sticking panel 30 is separated from the sucking head 10 and is replaced by a sucking and sticking panel 30 appropriate for the size of the balls B, ball mounting is performed by the same process as the above-mentioned process.

Therefore, in accordance with at least one embodiment of the invention, the ball mount module 100 minimizes a sucking and sticking defect of the balls B due to frictional force even though the balls B are moved and mounted in the state in which they are sucked and stuck by the ball sucking and sticking holes 32 and improves workability since the sucking and sticking panel 30 is rapidly replaced and used depending on the size of the balls B.

With the ball mount module according to an embodiment of the present invention, the sucking and sticking panel sucking and sticking the balls is detachably disposed at a front end portion of the sucking base made of a porous ceramic material, such that it may be installed so as to correspond to a size of the balls to be mounted. Therefore, since the entire module needs not to be replaced, a manufacturing cost may be significantly decreased.

In addition, the ball sucking and sticking hole is formed so as to have an inner diameter larger at a lower portion thereof than at an upper portion thereof to prevent a phenomenon that the ball is fitted, thereby making it possible to accurately mount the balls and significantly improve productivity.

Embodiments of the present invention may suitably comprise, consist or consist essentially of the elements disclosed and may be practiced in the absence of an element not disclosed, For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

As used herein, terms such as “first,” “second,” “one side,” “the other side” and the like are arbitrarily assigned and are merely intended to differentiate between two or more components of an apparatus, It is to be understood that the words “first,” “second,” “one side,” and “the other side” serve no other purpose and are not part of the name or description of the component, nor do they necessarily define a relative location or position of the component. Furthermore, it is to be understood that the mere use of the term “first” and “second” does not require that there be any “third” component, although that possibility is contemplated under the scope of the embodiments of the present invention.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A ball mount module comprising:
a sucking head;
a sucking base coupled to the sucking head and having irregular air channels; and
a sucking and sticking panel comprising ball sucking and sticking holes formed therein so as to be in communication with the irregular air channels of the sucking base and coupled to the sucking head.

2. The ball mount module according to claim I, wherein the sucking base is made of ceramic.

3. The ball mount module according to claim 1, wherein the sucking head is coupled to the sucking base while enclosing an upper surface and both side surfaces of the sucking base.

4. The ball mount module according to claim 1, wherein the sucking and sticking panel is detachably coupled to the sucking base.

5. The ball mount module according to claim 4, wherein the sucking and sticking panel is coupled to the sucking base by bolts.

6. The ball mount module according to claim 1, wherein the ball sucking and sticking hole is formed to have an inner diameter that becomes larger from a portion thereof closely adhered to the sucking base toward the outside.

7. The ball mount module according to claim 1, wherein the sucking and sticking panel comprises a plurality of ball sucking and sticking holes formed therein at predetermined intervals.

8. The ball mount module according to claim 1, wherein the ball sucking and sticking hole has a height lower than a radius of the ball.
